(19) United States
(12) Patent Application Publication
(10) Pub. No.: US 2009/0021213 A1
(43) Pub. Date: Jan. 22, 2009

(54) Method for pay-per-use, self-service charging of electric automobiles

(76) Inventor: Oriz Wickline Johnson, Cincinnati, OH (US)

Correspondence Address: Oriz W. Johnson, 2086 Butterwood Drive, Cincinnati, OH, 45241-1035, US

(21) Appl. No.: 11/880,084

(22) Filed: Jul. 20, 2007

(51) Int. Cl. H02J 7/00; G06Q 30/00

(52) U.S. Cl. 320/109; 705/1

(57) ABSTRACT

A method for pay-per-use, self-service charging of electric storage power systems of electric automobiles, said automobiles charged via electrical connections to a provided curbside charging station, said charging station automatically modifying grid electricity to be suitable for charging an array of said automobiles, said charging station also automatically securing electricity at off-peak rates when available and storing same for subsequent use.

### CROSS REFERENCES TO RELATED APPLICATIONS

None.

### FEDERALLY SPONSORED RESEARCH

None.

### MICROFICHE APPENDIX

None.

### BACKGROUND

1. Field of the Invention

Class 320/109

2. Background of the Invention

Because of the many possible non-polluting fuels to generate electricity and the use thereof, the validity of an electric automobile is very high. There are many versions of special purpose electric vehicles extant such as golf carts, tow motors, forklifts and scooters, and a goodly number of hybrid-electrics but few purely electrically powered passenger automobiles. Because batteries in use deplete their stored charge, they must be re-charged from time to time and there are special purpose charging apparati available for this purpose. Because chemical storage battery technology depends on a chemical reaction to generate electricity, it follows that in re-charging a chemical battery, care must be taken to insure the charging process is slow enough to allow the chemical reactions to unwind without molecular damage or without causing excessive heat which can cause internal plates or components within the battery to warp or melt.

Thusly, safely recharging heavy-duty batteries capable of powering a vehicle takes a long time, generally many hours. Lastly, because of the time required to recharge chemical batteries and the total absence of adequate charging facilities, owners of new style electric automobiles will employ an in-the-home-garage version of these present day chargers to re-charge their batteries at night, hoping not to deplete their battery charge the next day before they can get back home for a re-charge. But no matter how carefully done, chemical batteries can only be charged a certain number of times before the chemical reaction dissipates and the batteries become useless. This certain number generally occurs before the useful life of the automobile thus requiring very expensive replacement.

### OBJECTIVES AND ADVANTAGES OF THE INVENTION

Very recent application of sophisticated carbon nano-tube technology has improved an additional type of electrical storage device, the capacitor, and likewise, new carbon based composite materials enable yet another storage device, super high-speed flywheels, to now be both cheaper and competitive in electric storage capability with chemical batteries. Neither the capacitor nor the flywheel has chemicals requiring hours-long electrical unwinding, in fact, they have no chemicals at all, and more important, if sufficient charging power is properly applied, they can be re-charged not in hours but in only a few minutes, the time limited more by the power source and the integrity of the charging harness than the devices themselves.

Further unlike the chemical battery, both devices can be re-charged an infinite number of times, thus in the interest of even further charging time savings, they can be connected for only a partial charge if a full charge is not actually needed at the time. It is these characteristics of the newly technology-enabled electric storage systems for electric cars, particularly the capacitor, that will energize the driving community to quickly adopt this mode of propulsion, giving rise to the nationwide need for readily available rapid-response charging stations. The future production of electric cars requires neither the support of the automobile nor the oil industry and will be powered instead by a multitude of small manufacturing entrepreneurs, probably each with its unique propulsion system and requiring unique charging characteristics. Thusly the proposed invention has the capacity to provide a multitude of charging voltages, amperages and charging devices to service virtually any electric vehicle that might approach. Additionally, it will likely be that much of the initial vehicle production will be smaller runabout commuter cars produced in large numbers for use in urban areas requiring a minimum charge of electricity to serve their needs and further giving rise in very short order for the need for an intense network of charging stations. Happily because the re-charging of the capacitor can be as simple as filling one's auto tank with gas, the proposed charging stations can be small, self-serve, automatic profit-center devices mass produced and installed rapidly world wide again driven by entrepreneurial reward, standing alone not only at established gasoline stations but virtually anywhere a safe traffic accessible space and a supply of power-grid electricity is available. Moreover, unlike a gasoline pump with generally three grades of gasoline, the proposed invention provides sixteen and can just as easily provide thirty two or virtually any number if such a need should materialize in the future. While the charging mechanics for capacitors and flywheels are by nature considerably simpler than for a chemical battery, chemical battery development is proceeding at such rapid pace, it is expected that faster-charge batteries will soon emerge. The proposed invention will also accommodate chemical batteries. In its most extreme form, the charging station will enable a driver to pull his car alongside a charging station, enter credit card and charging specifications from the driver window, plug in a charging cord from the car window to the station, quickly receive the desired charge, pull the cord and drive away. In its more prosaic form, its initial application to accommodate the newer batteries as well as the fast charge devices, will most likely be in parking spaces at city, airport, hotel garages, motels, movie houses, sports stadiums and schools where instead of instant charge, there will be a slower charge of only a couple of hours or so and the car can be left at the charging station accordingly. As the batteries improve and the charging times decrease and the population of these electric cars multiplies, additional stations will appear at roadside rest areas, restaurants, barber and beauty shops, and any other location where the public must necessarily spend not hours but more than a very few minutes and where the shop owner wants to invest in the profit center device as additional income or as a service to its customers.

Hotels having tremendous daytime electrical needs have electrical power grid service substantial enough to charge a large number of electric cars at night and at off-peak rates. The proposed invention has provisions for smaller facilities having a lesser grid service than hotels and motels to accumulate a supply of charging electricity in a storage bank at nighttime off-peak rates for sale during the day.

### SUMMARY OF THE INVENTION

The invention is to be a self service, electronic-pay-per-use, stand alone automatic electric charging station capable of charging an array of electric automobile power systems including batteries, capacitors and flywheels with any of 16 species of charging power to meet the broad requirements of the driving public. Moreover the species can be easily expanded or modified to meet changing charging mores to be expected in the future. The station via a computer screen interrogation of the customer determines the nature of the charge desired and automatically modifies a supply of power grid electricity to meet and deliver precisely that amount to the connected automobile, electronically collecting the customer's payment and providing a payment receipt at the conclusion of the charging incident.

### DESCRIPTION OF THE DRAWINGS

FIG. 1: a block schematic of the major components of the entire system in abstract relationship.

FIG. 2: a block schematic of the internal components of the charging module component showing solenoid contactor switch arrangements for each component.

FIG. 3: a schematic diagram of the power wiring of the components within the charging module, showing solenoid contactor switch arrangements for each component.

FIG. 4: a schematic diagram of a computer chip pin connection scheme to the 24 volt relays and the intellectual components of the system.

FIG. 5: an oblique isometric of the charging station cabinet and the major components of its preferred embodiment.

FIG. 6: a side elevation of the internal arrangements of the charging station components of FIG. 6.

FIG. 7: a side elevation of the internal arrangement of an all-in-one, self contained version of the charging station wherein the charging module and the computer module as been added.

FIG. 8: a side elevation of the internal arrangement of the charging station wherein an electromagnetic transmitter coil has been added in lieu of charging and computer modules.

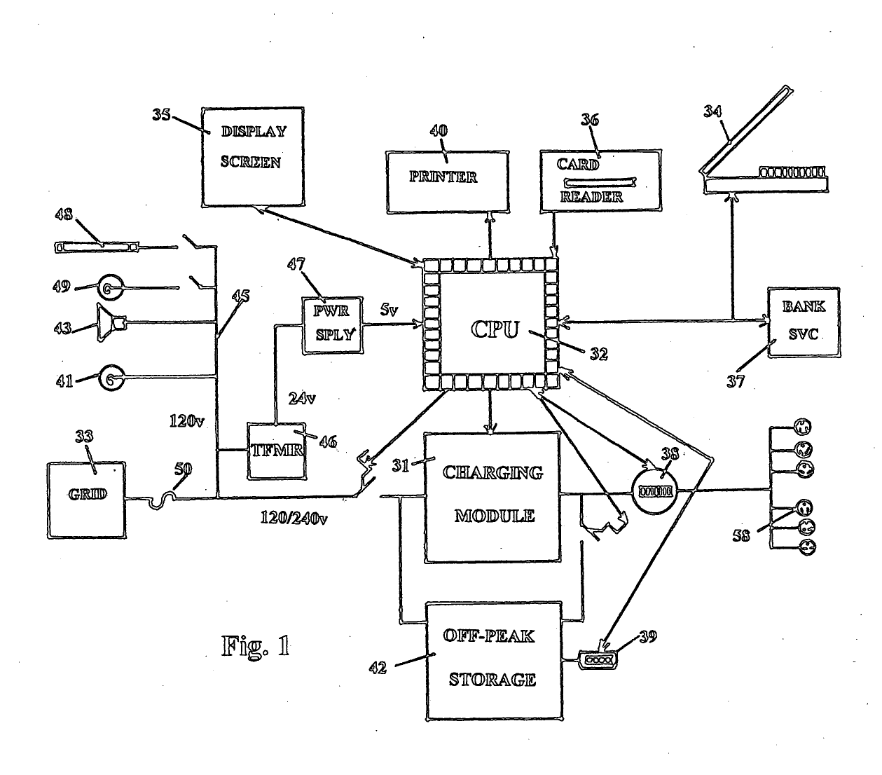

### LIST OF REFERENCE NUMBERS IN THE DRAWINGS

1-27 Solenoid contactor switches
31 Charging module
32 Computer module CPU
33 Power company grid
34 Site management computer
35 CPU display touch screen
36 Credit card reader
37 Banking service
38 KWH digital meter
39 Digital continuity tester
40 Receipt printer
41 Charging light
42 Off-peak storage
43 Audible alert
44 Off peak storage indicator
45 120 v circuit
46 120/24 transformer
47 CPU 5 v power supply
48 Tube light
49 Strobe light
50 Circuit breaker
51 Multi-tap AC transformer
52 Multi-tap DC converter
53 AC/DC rectifier
54 Charging station
55 Transmitter coil
58 Receptacles
59 DC to AC inverter
60 IGBT and driver module

### DESCRIPTION OF THE INVENTION

It is expected the invention can eventually take several operative configurations depending on the nature of the site where it is installed, but the version to be described is the one that is most appropriate until the automobile industry singles up or materially reduces the number of electric power configurations and until charging times are materially reduced.

Drawing #1 schematically displays generically the major operating components of the apparatus. These operating components are arranged in three major enclosures, the charging module, the computer module and the remote, curbside charging station. The first major enclosure, the charging module 31, contains an assembly of controllable inter-connectable electricity modification and control devices suitable and intended to modify the nature of the electric current from a power company grid or other source to meet specifications required to safely and properly charge varied electric storage systems of an array of electric automobiles, and in concert with the computer module, CPU 32, a programmable micro processor of adequate computing power, speed and memory capacity which is interconnect to and programmed to manipulate those devices and displays as are required to perform each charging incident, to with, convert the nature of the connected power from a power company grid 33 to that precisely required by a driver customer, transfer same and calculate all financial considerations of the electric automobile charging incident including contractual user fees due from the site management to the charging apparatus manufacturer/provider incurred for each charging incident. CPU 32 prior to automatically controlling or performing all steps of the charging operation, receives initial reference data input from the site management via site's computer 34 or touch screen 35 in response to a series of visible queries created by the computer and displayed on the site computer 34 or touch screen 35. CPU via similar screen queries and instructions enables customers to input credit card credentials and specifications of the charge desired and then verifies said customer credit credentials for the purchase of the electricity with a remote banking service 36 via telephone or internet. CPU tests continuity tester 39 which is closed when continuity is found indicating that the customer has inserted a charging cord into the station female charging receptacles 58 and that it is safe to energize the charging system. CPU using its internal clock mechanism and flow-rate input from KWH meter 30 as a reference datum plane, then energizes solenoid contacts, 1 to 25, within the charging module 31, to acquire a supply of charging electricity from power company grid 33 or other source, modify said acquired supply of grid electricity to meet the specifications and KWH of the charge desired, transfer the charge of modified electricity via the remote curbside charging station 54 to the storage system of the electric automobile. CPU instructs the customer step-by-step via the charging station display screen 35 how to charge his car, advises the banking service 36 of charges to be credited against the customer's account, the site account numbers to be debited, and provides the customer a printer 40 receipt for the cost of the charge received. CPU may also automatically debit the charging station manufacture's bank account with any contractual user fee required of the site location for each sale as well as federal, state and local tax obligations. During the electric charge transfer process, CPU turns on a charging light 41 at the remote charging station 54 indicating to the customer that a silent charging activity is taking place and an audible alert 43 of three seconds to alert the customer that the charge is complete and to remove his connection from the station.

Additionally, CPU arranges for the electrical charging of a storage bank 42, if any, during power company “off-peak” hours as defined by the site management and the use of this stored electricity to provide customer charging electricity rather than from the higher priced grid if charge level indicator 44 shows the stored charge level is adequate.

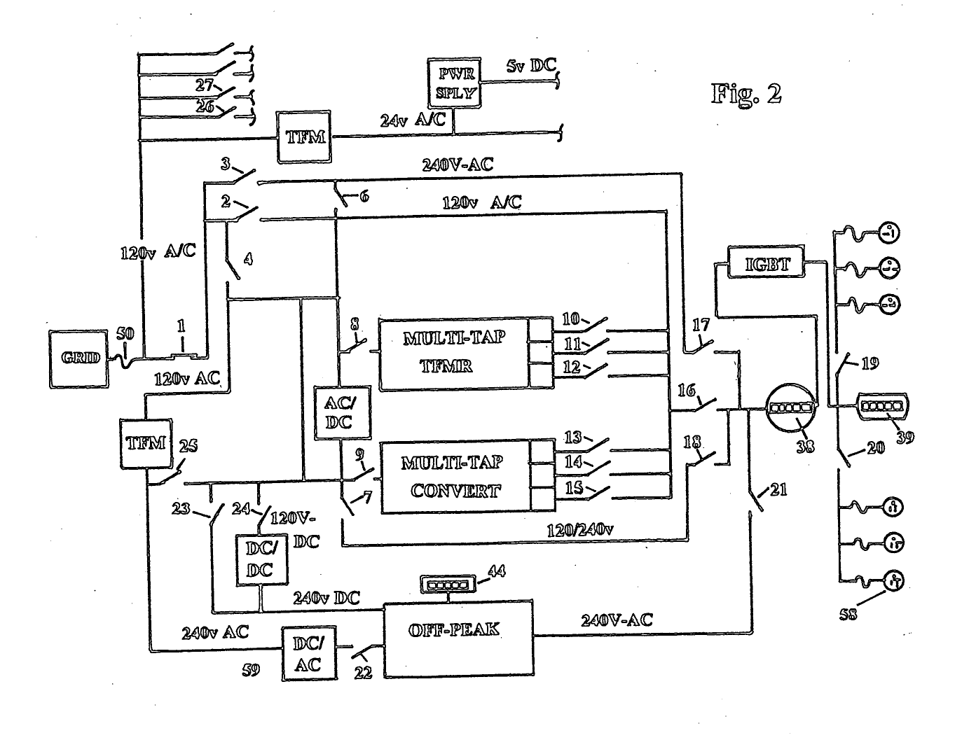

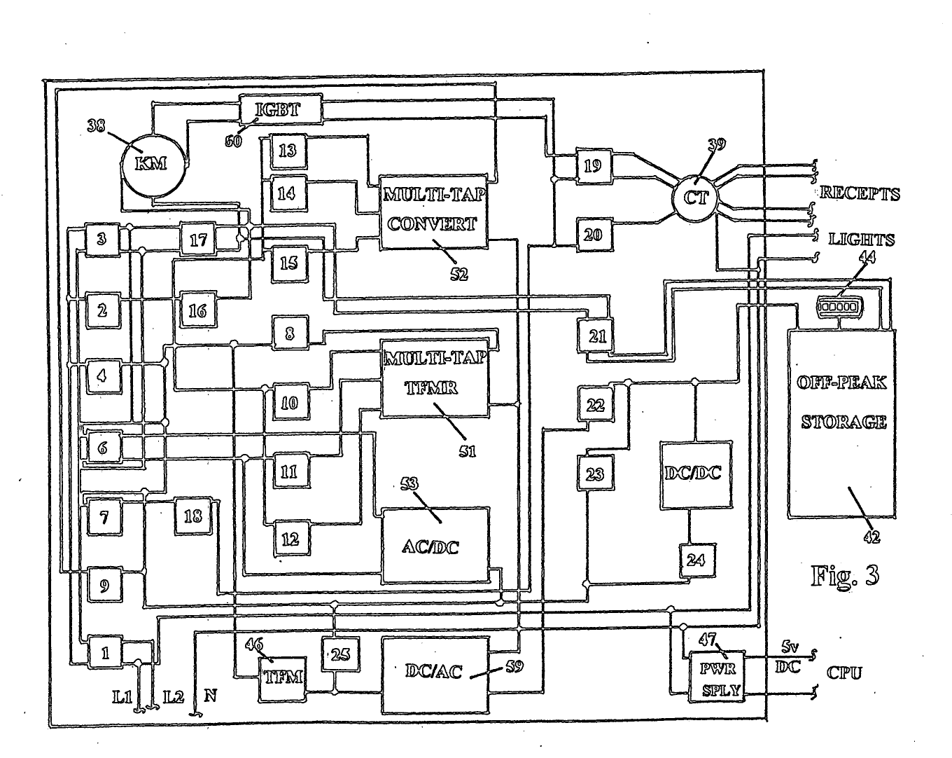

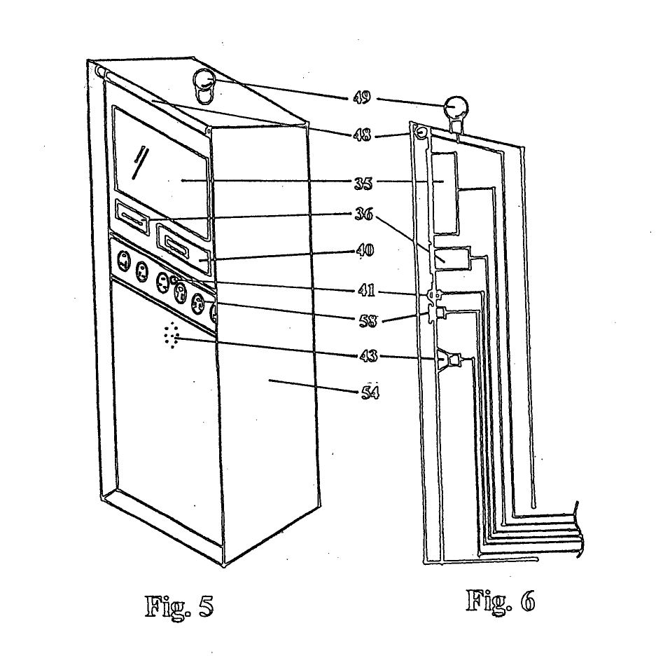

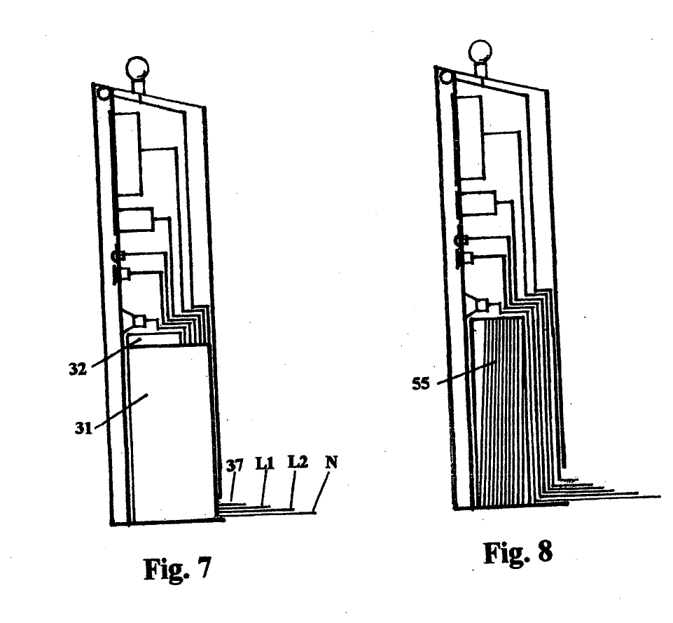

Additionally, CPU provides a number of running and historical accounting functions and stores same in memory to be harvested when and as desired. A very detailed description of each computer step and the roles of many electrical components are related in the computer processor programming instructions which follow. FIG. 2, a schematic display of the electrical power wiring to system components, to with, the 120 v circuit 45 to the 120/24 v transformer 46 which provides 24 v power to CPU power supply 47 which converts 24 v power to 5 v for the use of the CPU, and the 24 v control wiring for the twenty seven solenoid contactor switches, 1-25, in the charging module 31, FIGS. 2 and 3. The computer CPU module 32 also includes 27 5 v/24 v relays 55 FIG. 5, 25 of which are each dedicated to one solenoid contactor in the charging module. The relays are closed by CPU when and as required to modify grid electricity to that required by the customer. Power circuit 45 additionally provides 120 v power for the charging light 41, solenoid contact 26, the audible alert 43, solenoid contact 27, controlled by CPU relays 26 and 27 respectively, a fluorescent tube lighting 40 for nighttime illumination and a perpetually flashing, day and night, strobe attract light 49. Strobe and tube lights have a manual on/off switch. 120 v circuit 45 and thus the power to CPU is continuously on line and grid electricity is available to the entirety of the apparatus when the site circuit breaker 50 from the power grid 33 is closed. The circuit breaker remains closed unless intentionally opened or opened by an overload current. The charging module 31 can be taken off line via n/c contactor 1 by CPU as might be required for servicing or when off-peak storage facilities 44 are full. Major component MT 51 is a multi-tap AC transformer rendering three different AC voltages as ratios of the input voltage and as might be required to charge a capacitor or flywheel auto power source or autos with onboard battery chargers. Likewise, component CV 52 is a multi-tap DC voltage converter rendering three different DC voltages as ratios of the input voltage as might be required to charge a battery-type auto power source. AC/DC rectifier 53 enables 120 and 240 DC voltages. Direct connection to the grid via solenoid contacts 2 and 3 enables 120 and 240 AC voltages respectively. The net result is eight AC and eight DC voltage levels. IGBT power supply and driver module 60, down stream of Kilowatt hour digital meter 30 adjusts current amps to one of five levels as directed by CPU. The values of both the Multi-tap devices and the IGBT power supply are to be selected for the most popular auto charging requirements, and the values entered into the CPU control program as defined in the Computer Processor Flow Chart. If values become obsolete over time, the devices may be removed and new ones installed and the CPU re-instructed.

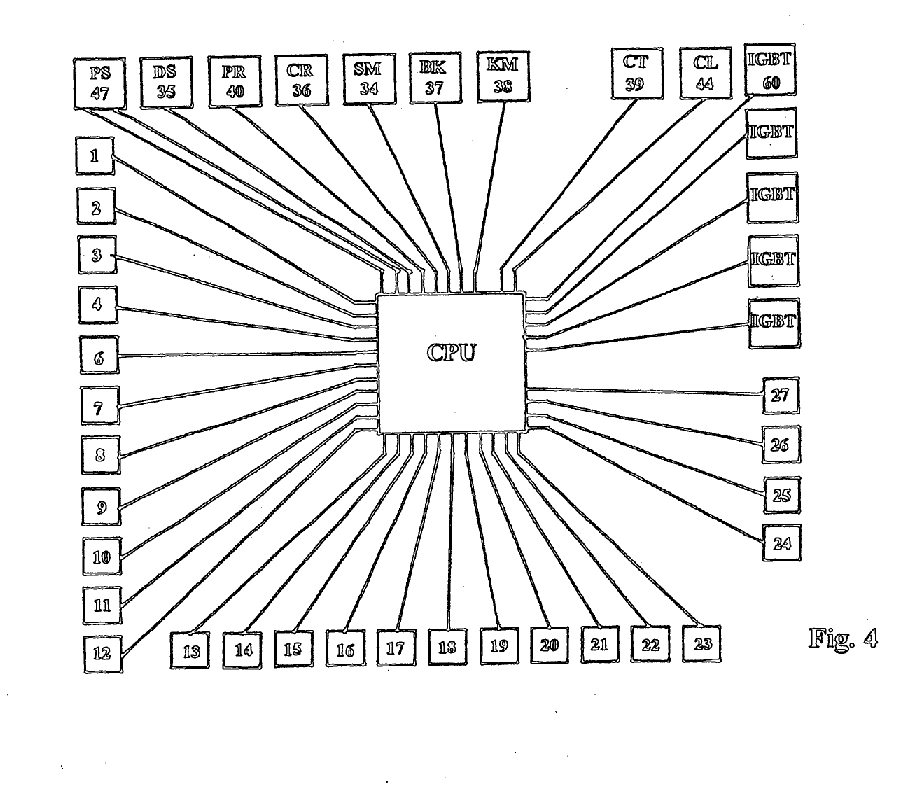

FIG. 3 an arrangement of the components and solenoid contactor switches of charging module 31 as shown in FIG. 2 into a self-contained enclosed cabinet suitable for close coupling to the computer module, CPU 32, and mounting both in tandem on the wall or on the floor of the equipment room of the site involved. The charging station 54, not shown, interconnected electrically to the charging module 31 is located outdoors with ready access for the driving public. The wiring system additionally includes, but are not shown, overload fuses, ground fault interrupters and RFI filters to insure safe, NEC and UL code approved, operation. FIG. 4, demonstrates CPU chip pin connections for 27 5 v/24 v relays, the 5 volt power supply 47, the display touch screen 35, the printer 40, the credit card reader 36, the site manager computer 34, the bank service 37, the KWH meter 38, the continuity tester 39, the off-peak storage level indicator 44 and the IGBT 60.

FIG. 6, the outdoor charging station 54 comprises a metal enclosure of adequate size to house such electrical components as are indicated. The enclosure is fixedly anchorable at an automobile-accessible parking space, and is structurally sturdy, waterproof and otherwise suitable for year-round outdoor installation and inclement weather service. Cables carrying the charging electricity are connected from the charging module 31 in the site equipment room to the remote charging station. In this preferred configuration the charging station is fitted with the display touch screen 35, the credit card reader 36, a receipt paper printer 40, an array of female charging cord receptacles 50, optionally a male paddle insertion device for those autos requiring same, the charging light 41, an audible alert 43, a tube illumination light 40 and attract strobe light 49. The charging station is sufficiently tall to keep the operative components above piled snow and customer operation devices to be reached by a driver from the driver window. The 240 v AC power supply may be employed to also energize the transmitter coil 55 of the embryonic WiTricity wireless charging technology system for batteries when such a electromagnetic transmitter coil is installed in the remote charging station 54, FIG. 8. In this futuristic manifestation, the charging station enclosure would be of non-metallic material.

### CONCLUSION, RAMIFICATIONS AND SCOPE OF THE INVENTION

While my above description contains many specificities, these should not be construed as limitations on the scope of the invention, but rather as an exemplification of one preferred embodiment thereof. Many other variations are possible, it is important to understand the several components can have various juxtapositions one to the other. For instance, the display screen 35, printer 36 and credit card reader 37 can be located in the charging station 54, or at the customer counter, or in a separate stand alone component within a retail space, not unlike an ATM. The credit card reader may be an insertion type, a proximity type, or one utilizing remote radio frequency information, RFI, capability. The site's existing credit card reader with its connections to the banking facilities may be employed. The charging station 54 sans screen, printer or reader, if located in a covered parking area of, say, a hotel could be a minimum security module standing only a foot or so tall and having but one or two popular charging receptacles, all arrangements and payment made inside the hotel or similar activity. The geometry of the charging station can assume virtually any definition as for instance, the charging module 31 can be reconfigured into a more vertical elongated geometry, and inserted along with the computer module 32 into the charging station 54,

FIG. 8 such that the entire apparatus is a single element. This arrangement is ideal for remote roadside sites such as along side interstate highways where charging shoulders might be constructed by adding an additional shoulder lane away from traffic so drivers in distress can safely pull alongside the station to get re-charged. Inasmuch as the station is automatic, weatherproof and contains no cash, it can installed in very remote locations to serve the interstate highway traffic. A hotel or other activity could issue debit cards to their repeat customers such that no banking services are required or handle all the payment activities through their normal sales desk credit card facilities. The means for modifying the grid power can be accomplished using other conversion techniques and devices and the definitions and number of levels of the modified electricity themselves can be different. Additionally, the solenoid contactor switches could be of the power transistor sort or solid state relays partially or wholly controlled by one or more programmable logic contacts. A simpler display screen and an alpha-numeric keyboard might be used in lieu of the touch screen or eliminated entirely with a voice communication to a remote human operator.

Accordingly, the scope of the invention should be determined not by the embodiments illustrated, but by the appended claims and their legal equivalents.

### Operation of the Invention:

Operation of the invention can best be seen in the Computer Processor Programming Instructions to follow.

### Computer Processor Programming Instructions:

1. Apparatus is constantly powered by 120 volt electrical supply connected to location power system grid 33. Micro-processor computer 32 is powered by 5-volt power supply 47 from said 120 volt power supply. Micro-processor also has continuous electronic communication connections to commercial banking service 37. Apparatus employs a commercially available credit card reader 36 having inherent pc program for handling banking.(card reader pc program and bank service interface program to be downloaded into CPU 32).

2. Location management energizes apparatus at main circuit breaker panel 50 and enters code numbers on touch screen 35, or alpha-numeric keyboard, on face of charging station 54 or location management computer 34, to open management dialog with computer CPU. CPU programmed to display following screen prompts and register reply input.

3. Programmer enters a user id, password and forgotten-words-recall protocol. With punch of one key on screen, screen displays instruction to enter ID ______ and password ______.

4. When correct ID and password entered screen DS displays question:

“What is grid supply voltage to the charging assembly?”

“What are the three tap voltages of the AC transformer, from highest to lowest for a 120 volt input?”

Tap 1: ______, Tap 2: ______, Tap 3: ______.

“What are the three tap voltages of the AC transformer, from highest to lowest for a 240 volt input?”

Tap 1: ______, Tap 2: ______, Tap 3: ______.

“What are the three tap voltages of the DC converter, from highest to lowest for 120 volt input?”

Tap 1: ______, Tap 2: ______, Tap3: ______. “What are the three tap voltages of tge DC converter, from highest to lowest for 240 volt input?”

Tap 1: ______, Tap 2: ______, Tap3: ______.

Note: 5 low-voltage levels from CPU to standard IGBT and drive module render amperage levels of 10, 20, 30, 40 and 50 amps respectively. If non-standard IGBT is employed, reset values according.

4. Display screen displays question: “What is minimum credit for sale? $______”

5. Display screen displays: “Sales price per kwh? ¢______?”

6. Display screen asks:

“Off-peak Charging? Yes or no”? “If yes, enter beginning and ending times, beginning ______ pm, ending ______ am.” “Weekends all off peak, yes or no?” “Is off-peak storage a capacitor C, flywheel F, or battery B?” ______

7. Display screen asks:

“What is name of activity providing this service?”

“What is address of activity?”

“What is date of charging station start up?

“What is bank service electronic address?” ______

“What is your account number?” ______

“What is present federal tax per KWH?” ______

“What is federal tax account number? ______

“What is present State tax per KWH? ______

“What is state tax account number? ______

“What is your percent of gross sale charger user fee?” ______

“What is charger user fee account number? ______

“What is charging station id number on nameplate?” ______

Location management obtains this required one-time-only information obtained from tax regulations, bank service and the machine specs provided by the apparatus manufacturer and enters same by punching in said data using touch screen 35, keyboard, or site computer 34. All data requested must be entered.

8. CPU registers all input and closes management dialog.

9. CPU displays sales price “Price per KWH is ¢______ per kwh” on display screen DS. Price is displayed continually until changed by location management or until temporarily replaced by subsequent screen displays.

10. Automobile driver customer finding price acceptable, inserts credit card in reader slot.

CPU using downloaded credit card reader program reads data, adds minimum credit required for standard charge of electricity per 4a above, and transmits same to banking service 37 via communication connection telephone or internet as appropriate.

11. Banking service rejects or authorizes sale via return signal to CPU.

12. If banking service rejects, CPU displays rejection message “Sorry, your credit has been denied.” on the display screen leaving said message on screen for 15 seconds, then back to “sales price” display per 7 above.

13. If banking service authorizes sale, CPU displays questions to driver on screen as to type of charge required. Driver responds to question via touch screen or alpha numeric keyboard, driver responds to questions displayed on screen. Four questions, one comment:
“What is voltage of the charge desired? Enter voltage ______.”
“Is charge AC or DC? Enter A or D ______”
“What is amperage of charge desired?”
“What is total dollar value of electric charge desired. $______.______”
“Thank you please plug in your charging cord”

14. a. Cpu to read numeric dollar input, calculate kwh to be delivered by dividing dollar value desired by dollar rate per KWH advertised on screen per 5 above,

b. Read beginning value of digital KWH meter, 38, add number of kwh calculated to establish charging cut-off point.

c. Read continuity status of continuity tester, 39, to determine that the charging cord is plugged in.

d. When continuity established, cpu interprets nature of power requested in 12 and energizes or de-energizes relays and solenoid contact switches as shown in Switch Schedule below to provide same.

CPU closes relays and contact switch series as shown starting with the highest number first and at one second intervals. CPU closes contact to Charging light 41 per switching schedule.

15. If no match for the customer's needs is found, display message on screen, “Sorry this station does not provide the type of power requested”. CPU records the unmatched voltages and request frequency of each in readable memory.

16. As safety measure, CPU reads KW being delivered and time passing on computer clock, CPU calculates KW per second delivery rate. CPU monitors delivery rate continuously taking readings every second.

17. CPU opens lowest relay and contactor first when KW delivery rate drops to zero indicating a fully charged level has been reached or pre-determined cutoff value as in 12 b has been reached, whichever comes first. CPU closes switch to audible alarm for 3 seconds.

18. CPU notes KWH 38 ending meter reading, retrieves KWH beginning value from memory and calculates KWH delivered. CPU multiplies the KWH delivered by cents price per kwh and advises banking service of cost to the customer.

19. CPU displays message, “Charge complete, please remove your charging cord”
Receipt requested? Press yes or no.

20. CPU reads continuity status of continuity meter, 39, CPU flashes message in 16 at one second intervals till charging connection is removed.

When 39 reads zero continuity, proving charging cord connection has been removed, CPU displays,
“______ kwh delivered, Your cost_$______ Dollars. Thank you. Please come again.”

21. If receipt requested, cpu directs printer to print receipt for amount in 19 above and showing name of location and date of service.

22. CPU leaves this final message for 30 seconds after connection cord removed then back to price per KWH display per 2a.

23. CPU calculates KWH delivered, date and time of day, total cost to customer, federal and state tax and charger user fee per delivered KWH and sends data to Bank account number along with particular charging station id number. Bank Service credits customer account for total cost, deducts bank's service fee, debits federal, state, and charger user fee accounts appropriately and debits location account for remainder.

24. CPU records in internet readable memory: date, time of day, customer electrical charging data and dollar amount of purchase requested, KWH actually delivered, machine id number and total sales price to bank service.

CPU keeps daily, weekly, monthly and yearly cumulative totals of above items as well as other items as listed in paragraph 7 above. CPU transmits total daily to site computer and charging station provider as back-up.

25. If off peak storage is involved per paragraph 6, CPU opens and closes designated contact switches per schedule at evening start and morning end times as defined in 6 to charge off-peak storage bank with electricity at low off-peak rates per switching schedule below.

### Switching Schedule

Condition A: Effective at all times if there is no “off-peak” storage capability. Test for continuity then close relays to switches as shown below in reverse order at one second intervals. Open all switches when KW delivery rate per second drops to zero or when KWH stop point is reached. Close relay #26 for 3 seconds at the close of all customer sales.

Condition B: Off peak facilities in place but charge level of storage bank is insufficient, i.e. equivalent to 10 KWH or less. As in condition A above, open all relays when charge is complete and close relay #26 for 3 seconds. Additionally, close relay 3, or 2 if 240 v not available, 17 and 21 anytime during off peak period when a sales is not in progress to charge storage. Close relay #1 to open N/C contact #1 when storage is fully charged.

Condition C: Off peak facilities in place charge level is 10 KWH or greater. Contact #1 is open and all sales come from storage bank.

Condition D: Off peak facilities in place. During off peak times and charge level of storage bank is greater than 10 KWH but not full, close relay 3, or 2 if 240 v not available, 17 and 21 anytime during off peak period when a sales is not in progress to charge storage. When bank is full, open relays 3 or 2,17,21 and close relay #1 to open contact #1 and take bank off grid.

| | Condition A & B | Condition C |
|---|---|---|
| AC-120 v | 2-16-20-26 | 1-22-4-2-16-19-26 |
| AC-120 v Tap 1 | 4-8-10-16-20-26 | 1-22-8-10-16-20-26 |
| AC-120 v Tap 2 | 4-8-11-16-20-26 | 1-22-8-11-16-20-26 |
| AC-120 v Tap 3 | 4-8-12-16-20-26 | 1-22-8-12-16-20-26 |
| AC-240 v | 3-17-19-26 | 1-22-6-17-19-26 |
| AC-240 v Tap 1 | 6-8-10-16-19-26 | 1-22-25-8-10-19-26 |
| AC-240 v Tap 2 | 6-8-11-16-19-26 | 1-22-25-8-11-19-26 |
| AC-240 v Tap 3 | 6-8-12-16-19-26 | 1-22-25-8-12-19-26 |
| DC-120 v | 4-7-18-20-26 | 1-24-7-18-20-26 |
| DC-120 v Tap 1 | 4-9-13-16-20-26 | 1-23-9-13-16-20-26 |
| DC-120 v Tap 2 | 4-9-14-16-20-26 | 1-24-9-14-16-20-26 |
| DC-120 v Tap 3 | 4-9-15-16-20-26 | 1-24-9-15-16-20-26 |
| DC-240 v | 3-6-7-18-19-26 | 1-23-7-18-19-26 |
| DC-240 v Tap 1 | 3-6-9-13-16-19-26 | 1-23-9-13-16-19-26 |
| DC-240 v Tap 2 | 3-6-9-14-16-19-26 | 1-23-9-14-16-19-26 |
| DC-240 v Tap 3 | 3-6-9-15-16-19-26 | 1-23-9-15-16-19-26 |

Note 1:
In each charging incident set low-voltage level in IGBT module to provide amperage level required by customer.
Note 2:
At the end of each charging incident close contact 27 to sound audible alarm for 3 seconds. Repeat at 10 second intervals until driver removes charging cord as signaled by continuity tester 39 opening.

I claim:

1: A method for pay-per-use, self-service charging of electric storage systems of electric automobiles including other vehicles, said automobiles or other vehicles to be charged to be removably electrically connected to a provided charging station, said method comprising providing a programmable micro-processor computer programmed to sequence and control the following steps of.
(a) enabling a customer to input the specific nature of the electric charge desired,
(d) securing a supply of raw electricity from power company grid or other source as required,
(e.) Modifying said supply of raw electricity to meet the specific nature of the electric charge requested,
(f.) transferring the specific charge of modified electricity to the automobile,
(g.) securing customer payment for the specific charge of modified electricity transferred.
whereby a driver of an electric automobile in need of a charge of electricity may park at the charging station, easily secure a whole or partial charge of electricity and pay for same with a credit card or equivalent, even in some cases without leaving the driver seat

2: A method as recited in claim 1, wherein said modifying step comprising providing a current modification module, an assembly of controllable inter-connectable electricity modification and control devices suitable and intended to modify the voltage and/or amperage nature of an electric current.

3: A method as recited in claim 1, wherein said securing step comprising electrically inter-connecting said current modification module to a power company electrical grid or other source when and as required.

4: A method as recited in claim 1, wherein said securing step further comprising providing an electrical storage bank and steps for acquiring a supply of grid electricity as recited in claim 3 during power company off-peak rate hours and storing said supply in said storage bank till needed.

4: A method as recited in claim 1, wherein said programmable micro-processor computer is interconnected with and appropriately programmed to automatically sequence and control directly or indirectly all electronic, electrical, and electromechanical components in all steps of operation.

5: A method as recited in claim 4, wherein said micro-processor control computer further programmed to perform calculations of all financial charges emanating from each charging incident and automatically and contemporaneously disburse the funds via electronic communication to and from a plurality of remote banking services and other addresses.

6: A method as recited in claim 5, wherein said programmable micro-processor is programmed to calculate the contracted user fee for each charging incident and debit same to manufacturer's bank account.

6: A method as recited in claim 1 wherein said provided charging station comprises an enclosure of adequate size to house such electrical components as are necessary to safely transfer a supply of charging electricity from said enclosure to a connected electric automobile.

7: A charging station as recited in claim 6, wherein said enclosure is fixedly anchorable at an automobile-accessible parking space, said enclosure being structurally sturdy, waterproof and otherwise suitable for year-round outdoor installation and inclement weather service.

8: A charging station as recited in claim 6 wherein said enclosure further having accessible female electrical charging connection devices and optionally, a male charging connection device, both electrically connected to the electrical components inside the enclosure.

9: A charging station as recited in claim 6 wherein said enclosure further having customer operation controls comprising an customer accessible credit card reader or equivalent and computer display touch screen, said customer operation controls digitally communicating with said control computer.

10: A charging station as recited in claim 6, wherein said structurally-sturdy enclosure is of adequate size and sufficient height to be easily reached from the driver window of an alongside passenger automobile and presenting driver easy access to customer-operation controls and charging connection devices exposed thereon.

11: A charging station as recited in claim 6, wherein said structurally-sturdy enclosure may be of adequate size and sufficient height to house all described components except said storage bank.

12: A method as recited in claim 8 wherein said customer operation controls may be optionally located in said outdoor charging station or other site locations.

13: A pay-per-use, self-service dispensing apparatus for modifying and dispensing electrical charges to electric power storage systems of electric automobiles including other vehicles, said automobiles or other vehicles to be charged to be removably electrically connected to a provided charging station, said dispensing apparatus comprising,
(a.) electric current modification means for modifying power company grid electricity to that suitable for any of an array of electric automobile power systems,
(b.) controlling means for electronically controlling the operation of said apparatus,
(c.) customer-input means for defining vehicle electric charge requirements and amount of charge desired,
(d.) power-acquisition means for securing a supply of power grid electricity as required, said acquisition means further comprising means for securing a supply of grid electricity during off peak hours and storing same till needed,
(e.) charge-dispensing means for transferring the charging electricity to the storage system of the electric automobile,
(f.) payment-collecting means for electronically securing payment from customers.
